(19) United States
(12) Patent Application Publication
(10) Pub. No.: US 2017/0293454 A1
(43) Pub. Date: Oct. 12, 2017

(54) DISCOVERY OF A PRINTING DEVICE VIA A REMOTE PLATFORM ACCESS CLIENT

(71) Applicant: Hewett-Packard Development Company, L.P., Houston, TX (US)

(72) Inventor: Jeffrey P BEERY, Boise, ID (US)

(21) Appl. No.: 15/518,204

(22) PCT Filed: Dec. 10, 2014
(86) PCT No.: PCT/US2014/069446

§ 371 Date: Apr. 10, 2017

(51) Int. Cl. G06F 3/12; G06K 15/00

(52) U.S. Cl. CPC G06F 3/1206; G06F 3/1228; G06F 3/1247; G06F 3/1288; G06K 15/4045; G06F 3/1292

(57) ABSTRACT

Examples disclosed herein relate to discovery of a printing device via a remote platform access client. Examples include a command from a remote platform server, via a remote platform protocol, for a remote platform access client to perform local discovery for at least one printing device. Examples further include identification of a discovered printing device not installed on a client computing device to a remote access server, and provision of print-ready print data to the discovered printing device without any rendering at the client computing device.

### BACKGROUND

A printing device, such as a printer, multifunction printer (MFP), or the like, may be utilized to print content on a physical medium such as paper. The printing device may receive an electronic representation of the content from a computing device, such as a desktop or laptop computer, a mobile device, etc. In some examples, the computing device may include a print driver to render the content into a print-ready format that the printing device is able to print and to provide the rendered content to the printing device.

### BRIEF DESCRIPTION OF THE DRAWINGS

The following detailed description references the drawings, wherein:

FIG. 1 is a block diagram of an example client computing device to discover an accessible printing device in response to a command from a remote platform server;

FIG. 2 is a block diagram of an example computing environment including a remote platform server to provide a command for a remote platform access client to perform local discovery for printing device(s);

FIG. 3 is a flowchart of an example method for discovering a locally accessible printing device with a remote platform access client; and

FIG. 4 is a flowchart of an example method for discovering and storing addresses of locally accessible printing devices with a remote platform access client.

### DETAILED DESCRIPTION

As noted above, a computing device may include a print driver to render print content into a print-ready format that a printing device is able to print, and to provide the rendered print content to the printing device. However, it may be difficult to print content from a computing device to a given printing device when the appropriate print driver is not installed on the computing device, for example.

As another example, when a user is working in a remote platform (e.g., remote desktop, etc.) hosted by a remote platform server, it may be difficult to print from the remote platform to a printing device local to the client computing device that the user is using to access the remote platform. In such examples, printing to the local printing device from within the remote platform may involve installation of appropriate print queues and print drivers at the remote platform server, the client computing device, or a combination thereof, Performing such installation processes prior to printing may be inconvenient and may be an inhibitor to users flexibly printing to an available local printing device, such as when the user is a guest in a new location and desires to print to printers at the location that are not installed for printing at the client computing device or the remote access server. Additionally, installation or other establishment of appropriate print queues and drivers may consume resources of the remote platform server, especially when a users print queues are recreated each time the user accesses the remote platform.

To address these issues, examples described herein may utilize a remote platform access client at a client computing device to perform local discovery for locally accessible printing devices that may be used without installing print queues at either the remote platform server or the client computing device. In examples described herein, a remote platform access client may acquire, via a remote platform protocol, a command from a remote platform server to perform local discovery for at least one printing device, discover a printing device that is accessible by the client computing device and that is not installed on the client computing device for printing, and provide identification of the discovered printing device to the remote platform server. In such examples, the remote platform access client may further acquire, from the remote platform server, a print instruction indicating the discovered printing device and print data in print-ready format for the indicated printing device, and provide the print-ready print data to the discovered printing device indicated in the print instruction without any rendering at the client computing device and bypassing the print system of the client computing device.

In this manner, examples described herein may enable flexible printing from a remote platform to a printing device locally accessible to a client computing device being utilized to access the remote platform, without installation of the printing device for printing at the client computing device (e.g., without a print queue or print driver at the client computing device) and without a print queue for the printing device at the remote, platform server. In some examples, the remote platform server may include a “dynamic print driver,” which may be a print driver capable of rendering content into any of a plurality of different print-ready formats for printing at different types of printing devices, respectively. In such examples, the remote platform access client may discover a printing device and capabilities of the discovered printing device, including a page description language (PDL) utilized by the discovered printing device The remote platform access client may provide this information to the remote platform server such that the dynamic print driver may render content for printing into print data in a print-ready format of the page description language for the indicated printing device, which the remote platform access client may then receive and provide to the printing device without any print queue or driver for the printing device at the client computing device.

In such examples, when a user is a guest at a new location, for example, the user may print from a remote platform to a locally accessible printing device at the guest location, without any print queue or driver being installed or established at the client computing device, and without a print queue being established at the remote platform server.

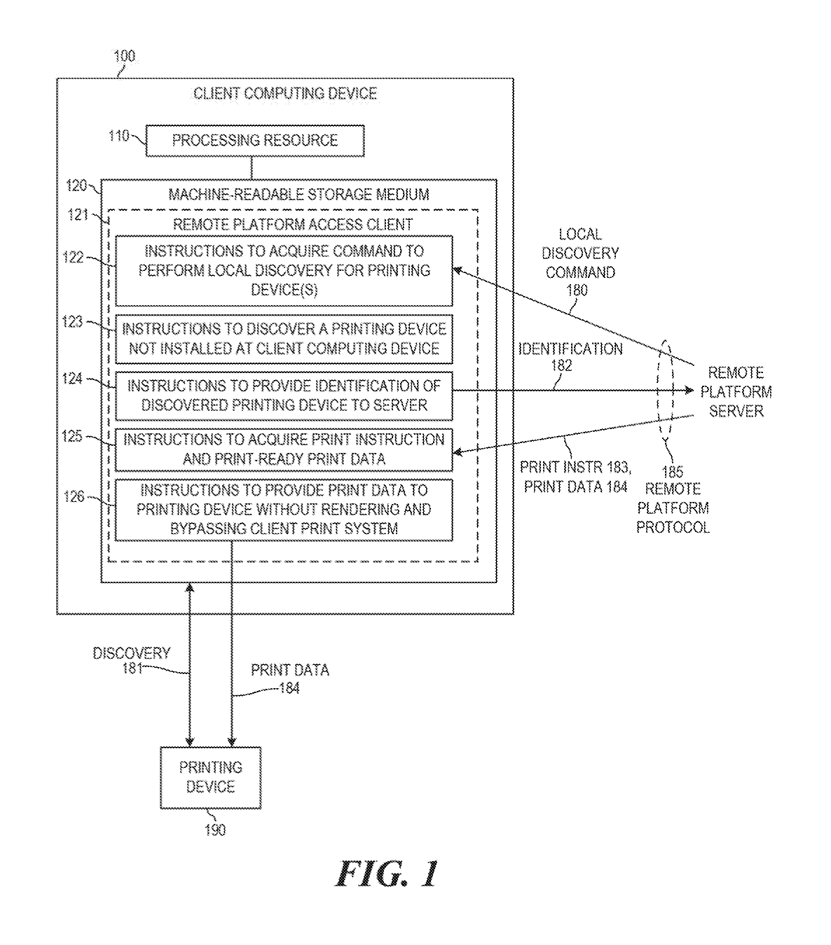

Referring now to the drawings, FIG. 1 is a block diagram of an example client computing device 100 to discover an accessible printing device 190 in response to a command 180 from a remote platform server. As used herein, a “computing device” may be a desktop computer, notebook computer, workstation, tablet computer, mobile phone, smart device, server, blade enclosure, printing device, or any other processing device or equipment.

In the example of FIG. 1, client computing device 100 includes a processing resource 110 and a machine-readable storage medium 120 encoded with instructions 122-126. In some examples, storage medium 120 may include additional instructions. In some examples, instructions 122-126, and any other instructions described herein in relation to storage medium 120, may be stored on a machine-readable storage medium remote from but accessible to computing device 100 and processing resource 110 (e.g., via a computer network), in examples described herein, a processing resource may include, for example, one processor or multiple processors included in a single computing device or distributed across multiple computing devices.

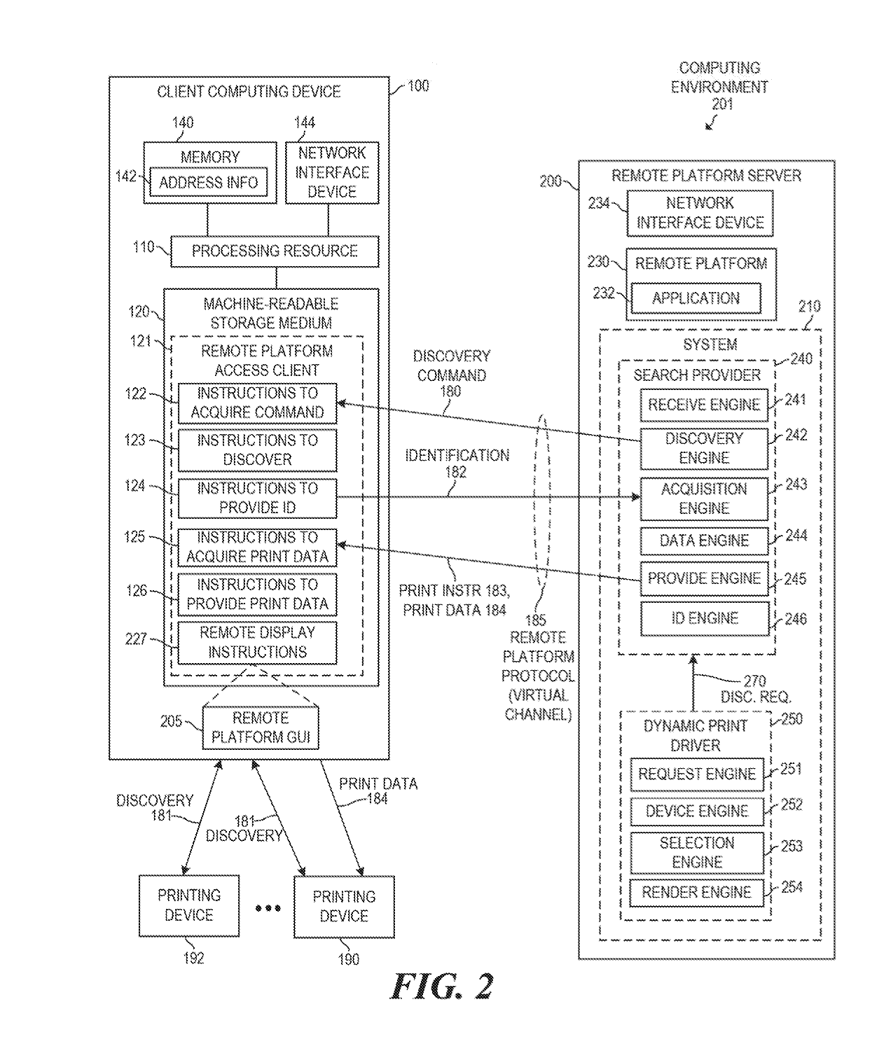

In the example of FIG. 1, client computing device 100 may also include a network interface device (e.g., network interface device 144 illustrated in FIG. 2). In examples described herein, a ‘network interface device’ may be a hardware device to communicate over at least one computer network. In some examples, a network interface may be a network interface card (NIC) or the like. As used herein, a computer network may include, for example, local area network(s) (LAN(s)), wireless local area network(s) (WLAN(s)), virtual private network(s) (VPN(s)), the Internet, telephone network(s) (e.g., cellular telephone network(s)), or the like, or a combination thereof.

In the example of FIG. 1, client computing device 100 may comprise a remote platform access client 121 to access a remote platform server via a remote platform protocol. In examples described herein, a “remote platform” may be a computing platform (or environment) implemented on computing device(s) (e.g., server(s)) remote from a client computing device utilized to display a graphical user interface (GUI) of the platform and to provide user input to the GUI displayed at the client computing device as input to the platform. Examples of such a remote platform may be a remote desktop environment, a hosted application environment, or the like.

In examples described herein, a “remote platform server” may be a server (e.g, computing device) that implements a remote platform (e.g., executes the remote platform utilizing hardware of the server) and utilizes a remote platform protocol to provide a GUI of the remote platform for display at a client computing device and to receive input to the remote platform from the client computing device. In examples described herein, a “remote platform access client” may be a computer application executed on a client computing device to communicate with a remote platform server to, for example, receive information useable to display a GUI of the remote platform at the client computing device and provide input received by the client computing device to the remote platform server as input to the remote platform. In examples described herein, a “remote platform protocol” may be a communication protocol utilized for communication over a computer network between a remote platform access client and a remote platform server to enable the remote platform access client to display a GUI of the remote platform at a client computing device and to provide, to the remote platform server, input to the remote platform received at the client computing device as input to the GUI.

In the example of FIG. 1, storage medium 120 may store instructions implementing remote platform access client 121. In such examples, the instructions implementing remote platform access client 121 may include instructions 122-126. Although schematically illustrated within remote platform access client 121 in FIG. 1, instructions 122-126 may in some examples be separate from other instructions of remote platform access client 121. For example, instructions 122-126 may be instructions of a plugin to remote platform access client 121. In such examples, when the plugin is installed, instructions 122-126, when executed, may cause the remote platform access client 121 to perform the functionalities described herein in relation to instructions 122-126. In some examples, remote platform access client 121 may perform functionalities provided by instructions 122-126 by calling those instructions when the plugin has been installed on client computing device 100. In other examples, some or all of instructions 122-126 may be a native (i.e., non-plugin) part of remote platform access client 121 and included with other instructions thereof.

In the example of FIG. 1, instructions 122 may actively acquire (e.g., retrieve, etc.) or passively acquire (e.g., receive, etc.) a command 180 from a remote platform server, via a remote platform protocol 185, to perform local discovery for at least one printing device. Remote platform protocol 185 may be a protocol to communicate between remote platform access client 121 and the remote platform server. In response to command 180, instructions 123 may discover 181 a printing device 190 that is accessible by client computing device 100 and that is not installed on client computing device 100 for printing. In some examples, printing device 190 may be connected to client computing device 100 directly (e.g., wired or wirelessly), or may be accessible to client computing device 100 via a computer network (e.g., via a local network connection) and is not directly accessible by the remote platform server.

In examples described herein, instructions 123 may perform “local discovery” to discover any printing device(s) that are directly connected to local hardware ports of client computing device 100 (e.g., connected to a port of client computing device 100, such as a USB port, or the like), accessible via a direct wireless connection, or connected to the same local network that client computing device 100 is connected to, in some examples, a “local network” that a computing device is connected to may include the portions of a computer network reachable by a network broadcast discovery process by the computing device, such as multicast Domain Name System (mDNS) discovery (e.g., Bonjour discovery, etc.), Web Services Dynamic Discovery (WS-Discovery), or the like. In some examples, the local network for the computing device may include at least one of a LAN, local subnet, collection of local subnets under a single domain name system (DNS), or the like, or a combination thereof, that the computing device is connected to.

In some examples, instructions 123 may perform, as part of the local discovery process, any suitable process to discover printing devices connected to the same local network as client computing device 100. For example, instructions 123 may perform mDNS discovery (e.g., Bonjour discovery, etc.), WS-Discovery, or any other suitable broadcast discovery process to discover printing device(s) on the same local network, LAN, local subnet, collection of local subnets under a single domain name system (DNS), as client computing device 100, or the like. In some examples, instructions 123 may broadcast a query for particular type(s) of devices onto the network that client computing device 110 is connected to, receive responses back from devices on the network, including printing device(s). In such examples, after receiving response(s) to the broadcast, instructions 123 may further communicate with the discovered printing devices to discover more about them, such as their capabilities, etc. in some examples, this further communication may be performed using the Internet Printing Protocol, or the like.

In examples described herein, instructions 123 may discover printing device(s) accessible on a local network to which client computing device 100 is connected (e.g., accessible by a network interface device of client computing device 100), but not directly accessible by the remote platform server (e.g., by the network interface device of the server). For example, the client computing device 100 and the remote platform server may be connected to different local networks, and as such, the network printing device(s) discovered by client computing device 100 may not be directly accessible by the remote platform server. In such examples, the discovered network printing device(s) may not be accessible to the remote platform server without establishment of a suitable virtual private network (VPN) connection between the networks or utilization of a client intermediary on the local network of the printing device(s), and thus may not be “directly” accessible to the remote platform server, as used herein.

In some examples, instructions 123 may interrogate local ports of client computing device 100 to discover any printing device(s) directly connected to client computing device 100 via a direct wired connection. In some examples, instructions 123 may utilize a wireless radio of client computing device 100 to scan for wireless access point(s) of printers accessible via any of various types of direct wireless connection (e.g., wireless direct, WIFI direct, or the like). In some examples, instructions 123 may perform discovery of directly connected printing device(s) connected via a wired direct connection, discovery of printing device(s) accessible via a wireless direct connection, and discovery of printing devices connected to the same local network as client computing device 100, or a combination thereof, as part of the local discovery process.

As noted above, instructions 123 may discover 181 a printing device 190 accessible by client computing device 100 and that is not installed on client computing device 100 for printing. In examples described herein, a printing device is not “installed for printing” at a given computing device when the computing device has no print queue installed (or otherwise established) for the given printing device. In some examples, the given printing device not being installed at the computing device may also mean that no print driver for the given printing device is installed on the computing device. In examples described herein, a “print driver” is a computer application to render (or convert) content to be printed into a print-ready format for at least one printing device. In the example of FIG. 1, discovered printing device 190 may have no print queue installed at client computing device 100 and may have no print queue installed at the remote platform server. In some examples, instructions 123 may discover a plurality of printing devices, including not-installed printing device 190, other not-installed printing device(s), other installed printing device(s), or a combination thereof. In such examples, not-installed printing device(s) may be among the printing device(s) discovered by the discovery process of instructions 123.

In some examples, as part of the local discovery process, instructions 123 may, for each discovered printing device, discover capabilities of the printing device, including a page description language (PDL) utilized by the printing device. A page description language utilized by a printing device indicates a form in which content may be printed by the printing device. In examples described herein, content represented in a page description language in which the content may be printed by a given printing device may be referred to as “print-ready” data for the given printing device. In some examples, content to be printed may be rendered (e.g., converted, etc.) into a print-ready format (e.g., a format in the appropriate page description language) for a given printing device before being provided to the printing device for printing. Examples of a page description language include versions of PCL (PCL3, PCL6, PCLm, etc.), portable document format (PDF), POSTSCRIPT, raster format, or the like.

In the example of FIG. 1, instructions 124 may provide identification 182 of the discovered printing device 190 to the remote platform server via the remote platform protocol 185 identification 182 may be any suitable identifier for printing device 190 (e.g., a string such as a name, address, etc.). Instructions 124 may also provide, to the remote platform server, identification of the page description language utilized by printing device 190.

In some examples, at remote platform server, discovered printing device 190 may be selected for printing content from the remote platform. In such examples, the remote platform server may utilize a dynamic print driver to render the content to the page description language indicated for printing device 190. In this manner, remote platform server may generate print data 184 in a print-ready format for printing device 190. In some examples, remote platform server may then provide, to remote platform access client 121, print data 184 and a print instruction 183 indicating that printing device 190 be provided print data 184 for printing.

In such examples, instructions 125 may acquire, from the remote platform server via remote platform protocol 185, print instruction 183 indicating printing device 190, and print data 184 in print-ready format for the indicated printing device 190. Print instruction 183 may indicate printing device 190 using the identification 182 acquired from remote platform access client 121. In some examples, print instruction 183 and print data 184 may be provided to remote platform access client 121 in different communications, or at least a portion of print data 184 may be provided in the same communication as print instruction 183. In response to print instruction 183, instructions 126 may provide print-ready print data 184 to discovered printing device 190 indicated in print instruction 183 without any rendering at client computing device 100 and bypassing the print system of client computing device 100.

In some examples, instructions 123 may determine (e.g., acquire) address information for discovered printing device 190 as part of the local discovery process, and may store this address information in memory of client computing device 100 in association with the identification 182 of printing device 190 (e.g., see address information 142 stored in memory 140, as illustrated in FIG. 2). The address information may be any suitable information useable by client computing device 100 to access discovered printing device 190, such as a host name, TCP/IP address, port, or the like. In such examples, instructions 126 may provide print data 184 to printing device 190 using the determined and stored address information associated with printing device 190.

As noted above, instructions 126 may provide print-ready print data 184 to printing device 190 without any rendering at client computing device 100 and bypassing the print system of client computing device 100. In such examples, print data 184 may be in a print-ready format for printing device 190, so instructions 126 may provide print data 184 to printing device 190 in the print-ready format in which print data 184 was acquired by remote platform access client 121 (i.e., client computing device 100), without any further rendering by any print driver at client computing device 100. Instructions 126 may also provide print data 184 to printing device 190 without accessing (e.g., calling, or the like) any print system of any operating system (OS) of client computing device 100. Such a print system may be, for example, a system that may be invoked by an application (e.g., program) on client computing device 100 via application programming interface (API) or OS system calls to invoke various native printing functionalities of client computing device 100, such as print commands, drawing commands, spooling functionalities, or the like, that may be used by client computing device 100 to print content from a local application installed on client computing device 100. In some examples, a print system may utilize a print driver in performing printing operations. As noted above, instructions 126 may provide print data 184 to printing device 190, bypassing (i.e., without calling or otherwise using) the print system of client computing device 100. For example, instructions 126 may provide print data 184 to printing device 190 without invoking the functionalities provided by the print system and without utilizing any print driver of client computing device 100.

In some examples, instructions 123 may discover a plurality of printing devices via the, local discovery process. In such examples, in response to command 180, instructions 123 may perform a broadcast discovery process to discover a plurality of printing devices that are accessible by the client computing device and not installed on client computing device 100 for printing. In this broadcast discovery process, instructions 123 may also discover respective capabilities of each of the discovered printing devices, such as a page description language utilized, and capabilities relating to color printing, duplex, paper sizes, media types, tray, and the like. In such examples, instructions 124 may provide identification of each of the discovered printing devices and their capabilities to the remote platform server via the remote platform protocol. In such examples, one of the discovered printing devices may be selected, at the remote platform server, for use in printing content. In some examples, instructions 123 may also discover installed printing device(s).

in other examples, instructions 123 may perform a directed discovery process to discover at least one specified printing device. In some examples, a printing device identifier (e.g., host name, Internet protocol (IP) address) may be provided to the remote platform (e.g., via input to a GUI of the remote platform displayed at client computing device 100) for use in printing device discovery. In such examples, instructions 122 may acquire the printing device identifier in association with the local discovery command 180 (e.g., command 180 may include the printing device identifier). In such examples, instructions 123 may perform a lookup operation (e.g., a DNS lookup or simple network management protocol (SNMP) lookup) using the printing device identifier to perform a directed discovery of the identified printing device. In some examples, instructions 123 may perform both the above-described broadcast discovery process and the directed discovery process in response to command 180.

In some examples, communications between remote platform server and instructions 122-126 (e.g., instructions of a plugin for remote platform access client 121) may be provided via a virtual channel of remote platform protocol 185. For example, the virtual channel may provide a named endpoint for the remote platform access client and the remote platform server to utilize for communications related to the local discovery and local printing processes described above. In such examples, other communications between the remote platform server and remote platform access client 121 may not utilize the virtual channel (e.g., communications relating to display of the GUI at client computing device 100 or input to the GUI provided to the remote platform server by client computing device 100).

In the example of FIG. 1, communications provided between client computing device 100 and the remote platform server may, be provided over computer network(s) (e.g., including the Internet) via a network interface device of client computing device 100 and a network interface device of the remote platform server. For network printing device(s) locally accessible to client computing device 100, client computing device 100 may utilize its network interface device to discover and communicate with such printing device(s).

As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. Processing resource 110 may include one processor or multiple processors. Processing resource 110 may fetch, decode, and execute instructions stored on storage medium 120 to perform the functionalities described above. In other examples, the functionalities of any of the instructions of storage medium 120 may be implemented in the form of electronic circuitry, in the form of executable instructions encoded on a machine-readable storage medium, or a combination thereof.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory. In examples described herein, a machine-readable storage medium or media is part of an article (or article of manufacture). An article or article of manufacture may refer to any manufactured single component or multiple components. The storage medium may be located either in the computing device executing the machine-readable instructions, or remote from but accessible to the computing device (e.g., via a computer network) for execution.

In examples described herein, a first computing device “remote” from a second computing device may be a first computing device that is separate from, and not directly connected to, the second computing device, wherein the first and second computing devices may access one another over a computer network.

In some examples, instructions 122-126 may be part of an installation package that, when installed, may be executed by processing resource 110 to implement the functionalities described herein in relation to instructions 122-126. In such examples, storage medium 120 may be a portable medium, such as a CD, DVD, or flash drive, or a memory maintained by a server from which the installation package can be downloaded and installed. In other examples, instructions 122-126 may be part of an application, applications, or component already installed on client computing device 100 including processing resource 110. In such examples, the storage medium 120 may include memory such as a hard drive, solid state drive, or the like. in some examples, functionalities described herein in relation to FIG. 1 may be provided in combination with functionalities described herein in relation to any of FIGS. 2-4.

FIG. 2 is a block diagram of an example computing environment 201 including a remote platform server 200 to provide a command 180 for a remote platform access client 121 to perform local discovery for printing device(s). In the example of FIG. 2, computing environment 201 comprises a client computing device 100, as described above in relation to FIG. 1, a plurality of printing device (including printing devices 190, 192, etc.), and remote platform server 200. In the example of FIG. 2, remote platform server 200 comprises a network interface device 234, a remote platform 230 implemented by server 200, and a system 210. In the example of FIG. 2, system 210 includes a search provider 240 comprising engines 241-246 and includes a dynamic print driver 250 comprising engines 251-254.

In the example of FIG. 2, an application 232 may be executed on remote platform 230. The application may be any suitable computer application, such as a word processing (or other productivity application), or the like. In some examples, remote platform access client 121 and remote platform server 200 may communicate, using remote platform protocol 185, such that remote platform access client 121 may display a GUI 205 of remote platform 230 at client computing device 100 (e.g., with remote display instructions 227), receive input to the displayed GUI 205, and provide the received input to server 200, for server 200 to process as input to the remote platform 230. In such examples, a user of client computing device 100 may utilize application 232 executing on remote platform 230 via client computing device 100 (providing access to the application 232 via remote platform access client 121). In the example of FIG. 2, storage medium 120 may comprise instructions 227. In other examples, instructions 227 may be stored in another machine-readable storage medium of client computing device 100. In examples described herein, remote platform access client 121 may utilize network interface device 144 to communicate with remote platform server 200 over computer network(s) (e.g., including the Internet), and remote platform server 200 may utilize network interface device 234 to communicate with remote platform access client 121 over computer network(s).

In the example of FIG. 2, a user of client computing device 100 may interact with application 232 of remote platform 230 via the GUI 205 displayed at client computing device 100 by remote platform access client 121. In some examples, via GUI 205 at client computing device 100, the user may select to print content from application 232 executing in remote platform 230, and in response, application 232 may provide a request to print to dynamic print driver 250 of server 200. In such examples, request engine 251 of driver 250 may actively or passively acquire, from application 232, the request to print the content (e.g., content being viewed with or otherwise open in application 232).

In response, engine 251 may provide, to search provider 240, a request 270 to discover available printing devices available for printing. In the example of FIG. 2, a receive engine 241 of search provider 240 may receive, from a dynamic print driver 250, the request 270 to perform discovery of printing devices. In response to request 270, discovery engine 242 may provide a command 180 to remote platform access client 121 to perform local discovery for at least one printing device. Engine 242 may provide the command 180 to client 121 via (i.e., using) remote platform protocol 185.

In such examples, instructions 122 of client computing device 100 may acquire the command 180, and in response, instructions 123 may discover 181 a printing device 190 that is accessible by the client computing device (e.g., by direct wired connected, direct wireless connection, or via a computer network) and that is not installed on the client computing device for printing, as described above in relation to FIG. 1. For example, instructions 123 may perform a local discovery process, including at least one of a broadcast discovery process and a directed discovery process, as described above. Instructions 123 may also discover capabilities of the discovered printing device 190, including a page description language utilized by the discovered printing device 190, as described above. In some examples, instructions 123 may determine address information 142 for the discovered printing device 190 as part of the local discovery process, and may store this address information 142 in memory 140 of client computing device 100 in association with an identification 182 of printing device 190, as described above.

In such examples, instructions 124 may provide, via remote platform protocol 185, identification 182 of the discovered printing device to the remote platform server, and identification of a page description language utilized by printing device 190. In some examples, the identification of the page description language may be provided with the communication of identification 182.

In the example of FIG. 2, acquisition engine 243 may actively or passively acquire, from remote platform access client 121 identification of printing device 190, discovered by the remote platform access client 121 in response to the command 180, and identification of the page description language utilized by the identified printing device 190. As noted above, the discovered printing device 190 is not installed on client computing device 100 for printing. In some examples, no print queue exists for the discovered printing device 190 at either remote platform server 200 or client computing device 100, as described above in relation to FIG. 1.

In the example of FIG. 2, an identification engine 246 may provide, to dynamic print driver 250, the identification 182 of discovered printing device 190 and the identification of the page description language utilized by printing device 190, acquired with engine 243. In such examples, a device engine 252 of driver 250 may acquire the identification 182 of the discovered printing device 190 and identification of the page description language utilized by printing device 190. A selection engine 253 may display, in remote platform 230 (and thus in GUI 205), an input selection menu identifying available printing devices, including printing device 190. In some examples, engine 253 may acquire selection of printing device 190 (e.g., in response to selection of printing device 190 via GUI 205), and in response, a render engine 254 may render the content to be printed from application 232, to generate print data 184 in a print-ready format of the identified page description language for selected printing device 190. A data engine 244 of search provider 240 may acquire, from dynamic print driver 250, print data 184 in the print-ready format of the identified page description language for printing device 190. In some examples, selection engine may also display and receive options relating to other capabilities (e g color, duplex, etc), and render engine 254 may perform the rendering in accordance with the selections.

In the example of FIG. 2, a provide engine 245 of search provider 240 may provide, to remote platform access client 121 via the remote platform protocol 185, print data 184, and a print instruction 183 indicating the discovered printing device 190 (e.g., via identification 182) and instructing the remote platform access client 121 to provide the print data 184 to the indicated printing device 190. In such examples, as described above, instructions 125 of client computing device 100 may acquire, from server 200 via remote platform protocol 185, print instruction 183 indicating the discovered printing device 190 and print data 184 in print-ready format for the indicated printing device 190.

In response to print instruction 183, instructions 126 may provide print-ready print data 184 to the discovered printing device 190 indicated in print instruction 183 without any rendering at the client computing device and bypassing the print system of client computing device 100, as described above. For example, instructions 126 may access and use the determined address information 142, for printing device 190, to provide the print-ready print data 184 to the discovered printing device 190. In such examples, provide engine 245 may provide the print data 184 in the print-ready format to the discovered printing device 190 via the remote platform access client 121 without any rendering at client computing device 100 and bypassing the print system of client computing device 188, by providing the above-described print instruction 183 and print data 184 to remote platform access client 121, as described above.

As described above in relation to FIG. 1, the print data 184 is provided to printing device 190 without installing any print queue for printing device 190 at either remote platform server 200 or client computing device 100. In some examples, some communications between remote platform access client 121 and search provider 240 may be provided via a virtual channel of remote platform protocol 185. in such examples, print data 184 may be provided from remote platform server 200 to remote platform access client 121 via the virtual channel. Other communications related to instructions 122-126 may also be provided via the virtual channel. In such examples, other communications between the remote platform server and remote platform access client 121 may not utilize the virtual channel, such as communications relating to remote display instructions 227 (e.g., communications relating to display of the GUI at client computing device 100 or input to the GUI provided to the remote platform server by client computing device 100).

In some examples, as described above in relation to FIG. 1, instructions 123 may discover a plurality of locally accessible printing devices via the local discovery process. For example, instructions 123 may discover a plurality of printing devices 190, 192, etc., each accessible by client computing device 100 and not installed on the client computing device for printing, as described above. Instructions 123 may also discover and their respective capabilities (e.g., page description languages utilized, etc.) and their respective address information (e.g., information 142, which may be stored in memory 140), as described above. In such examples, instructions 124 may provide, to remote platform server 200, identification of each of the discovered printing devices and their capabilities.

In the example of FIG. 2, acquisition engine 243 of server 200 may acquire, from remote platform access client 121, the respective identification of each of the plurality of printing devices discovered by remote platform access client 121 and not installed on client computing device 121 for printing, and identification of their respective page description languages. In such examples, an identification engine 248 may provide the acquired printing device identification and capabilities (e.g., page description language) information for each discovered printing device to driver 250. In such examples, selection engine 253 of driver 250 may display, via remote platform 230 and GUI 205, an input selection menu identifying available printing devices, including the discovered printing device. In some examples, engine 253 may acquire selection of one of the printing devices (e.g., in response to selection of one of the printing devices via GUI 205), and in response, a render engine 254 may render the content to be printed from application 232, to generate print data 184 in a print-ready format of the identified page description language for selected printing device. A data engine 244 of search provider 240 may acquire, from dynamic print driver 250, print data 184 in the print-ready format of the identified page description language for the printing device. In such examples, engine 245 may provide the print data 184 in the print-ready format to the selected printing device via the remote platform access client 121 without any rendering at client computing device 100 and bypassing the print system of client computing device 100, as described above.

Each of engines 241-246 and 251-254 of system 210 may be any combination of hardware and programming to implement the functionalities of the respective engine. In examples described herein, such combinations of hardware and programming may be implemented in a number of different ways. For example, the programming for the engines may be processor executable instructions stored on a non-transitory machine-readable storage medium and the hardware for the engines may include a processing resource to execute those instructions. In such examples, the machine-readable storage medium may store instructions that, when executed by the processing resource, implement engines 241-246 and 251-254, in such examples, system 210 may include the machine-readable storage medium storing the instructions and the processing resource to execute the instructions, or the machine-readable storage medium may be separate but accessible to system 210 and the processing resource. in some examples, programming of search provider 240 may be provided as a plugin to a remote platform server environment for hosting remote platform(s).

In some examples, the instructions can be part of an installation package that, when installed, can be executed by the processing resource to implement at least engines 241-246 and 251-254. In such examples, the machine-readable storage medium may be a portable medium, such, as a CD, DVD, or flash drive, or a memory maintained by a server from which the installation package can be downloaded and installed. In other examples, the instructions may be part of an application, applications, or component already installed on system 210 including the processing resource. in such examples, the machine-readable storage medium may include memory such as a hard drive, solid state drive, or the like. In other examples, the functionalities of any engines of system 210 may be implemented in the form of electronic circuitry.

In some examples, functionalities described herein in relation to FIG. 2 may be provided in combination with functionalities described herein in relation to any of FIGS. 1, 3, and 4.

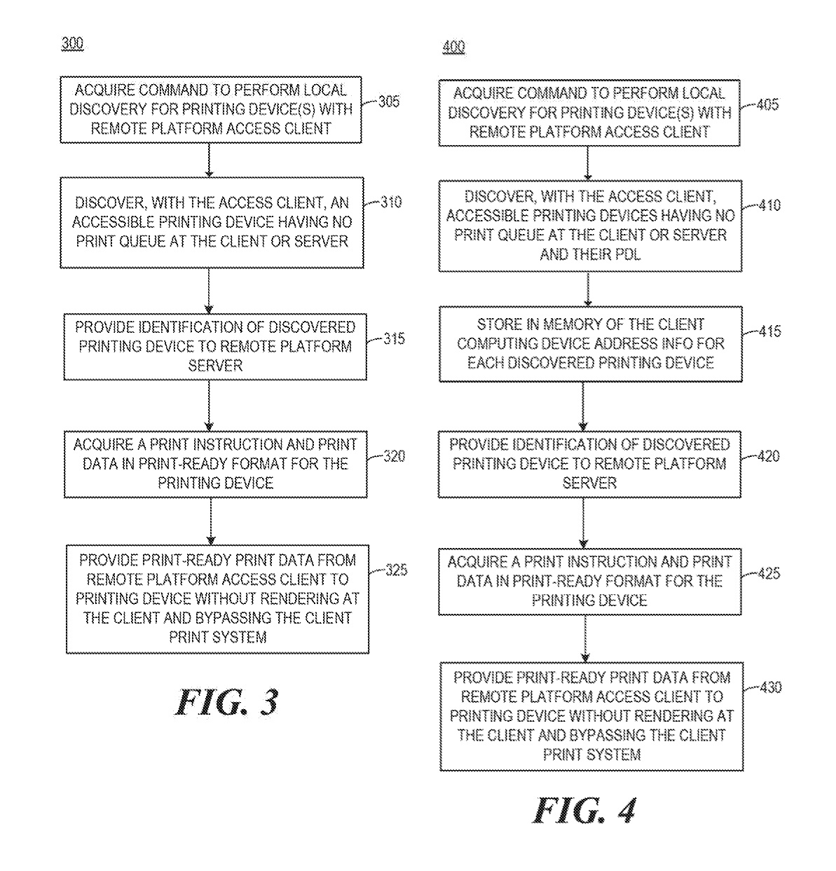

FIG. 3 is a flowchart of an example method 300 for discovering a locally accessible printing device with a remote platform access client. Although execution of method 300 is described below with reference to client computing device 100 of FIGS. 1 and 2 described above, other suitable computing devices for the execution of method 300 can be utilized. Additionally, implementation of method 300 is not limited to such examples.

At 305 of method 300, instructions 122 of client computing device 100 may acquire a command 180 to perform local discovery for at least one printing device. Instructions 123 may acquire command 180 from remote platform server (e.g., server 200 of FIG. 2) via a remote platform protocol 185, as described above. At 310, in response to command 180, instructions 123 may discover a locally accessible printing device 190 and a page description language utilized by the discovered printing device 190, as described above. In some examples, the discovered printing device has no print queue installed on either of client computing device 100 or the remote platform server. In some examples, no print driver is installed at client computing device 100 for the discovered printing device 190.

At 315, instructions 124 may provide, from the remote platform access client to the remote platform server via the remote platform protocol 185, identification 182 of the discovered printing device 190 and the page description language. At 320, instructions 125 may acquire, from the remote platform server via remote platform protocol 185, a print instruction 183 indicating the discovered printing device 190, and print data 184 in print-ready format of the discovered page description language for the indicated printing device 190. At 325, in response to print instruction 183, instructions 126 may provide the print-ready print data 184 from remote platform access client 121 to the discovered printing device 190 indicated in the print instruction 183 without any rendering of the print data 184 at client computing device 100 and bypassing the print system of client computing device 100.

In some examples, method 300 may be performed by remote platform access client 121 of FIG. 1. in such examples, the remote platform access client 121 may perform the functionalities of method 300 via instructions 122-128. Although the flowchart of FIG. 3 shows a specific order of performance of certain functionalities, method 300 is not limited to that order. For example, the functionalities shown in succession in the flowchart may be performed in a different order, may be executed concurrently or with partial concurrence, or a combination thereof. In some examples, functionalities described herein in relation to FIG. 3 may be provided in combination with functionalities described herein in relation to any of FIGS. 1, 2, and 4.

FIG. 4 is a flowchart of an example method 400 for discovering and storing addresses of locally accessible printing devices with a remote platform access client. Although execution of method 400 is described below with reference to client computing device 100 of FIGS. 1 and 2 described above, other suitable computing devices for the execution of method 400 can be utilized. Additionally, implementation of method 400 is not limited to such examples.

At 405 of method 400, instructions 122 of client computing device 100 may acquire a command 180 to perform local discovery for at least one printing device. Instructions 123 may acquire command 180 from remote platform server (e.g., server 200 of FIG. 2) via a remote platform protocol 185, as described above. At 410, in response to command 180, instructions 123 may discover a plurality of locally accessible printing devices and respective page description languages utilized by the discovered printing devices. In some examples, the discovered printing devices each have no print queue installed on either of client computing device 100 or remote platform server 200. In some examples, no print driver is installed at client computing device 100 for any of the discovered printing devices.

At 415, instructions 123 may, for each discovered printing device, store in memory 140 of client computing device 100, address information (e.g., information 142) useable to access the printing device. At 420, instructions 124 may provide, from the remote platform access client to the remote platform server via the remote platform protocol 185, identification 182 of each of the discovered printing devices and the respective page description language utilized by each.

At 425, instructions 125 may acquire, from the remote platform server via remote platform protocol 185, a print instruction 183 indicating one of the discovered printing device and print data 184 in print-ready format of the discovered page description language for the indicated printing device. At 430, in response to print instruction 183, instructions 126 may provide the print-ready print data 184 from remote platform access client 121 to the identified printing device 190 indicated in the print instruction 183, using the stored address information for the indicated printing device, and without any rendering of the print data 184 at client computing device 100 and bypassing the print system of client computing device 100.

In some examples of method 400, remote, platform server 200 and remote platform access client 121 communicate with one another via a virtual channel of remote platform protocol 185, as described above. In some examples, method 400 may be performed by remote platform access client 121 of client computing device 100 of FIGS. 1 and 2. In such examples, the remote platform access client 121 may perform the functionalities of method 400 via instructions 122-126. Although the flowchart of FIG. 4 shows a specific order of performance of certain functionalities, method 400 is not limited to that order. For example, the functionalities shown in succession in the flowchart may be performed in a different order, may be executed concurrently or with partial concurrence, or a combination thereof. In some examples, functionalities described herein in relation to FIG. 3 may be provided in combination with functionalities described herein in relation to any of FIGS. 1-3.

What is claimed is:

1. A non-transitory machine-readable storage medium comprising instructions executable by a processing resource of a client computing device to cause a remote platform access client to:
acquire, via a remote platform protocol, a command from a remote platform server to perform local discovery for at least one printing device;
in response to the command, discover a printing device that is accessible by the client computing device and that is not installed on the client computing device for printing;
provide, via the remote platform protocol, identification of he discovered printing device to the remote platform server;
acquire, from the remote platform server via the remote platform protocol, a print instruction indicating the discovered printing device and print data in print-ready format for the indicated printing device; and
in response to the print instruction, provide the print-ready print data to the discovered printing device indicated in the print instruction without any rendering at the client computing device and bypassing the print system of the client computing device.

2. The storage medium of claim 1, wherein the instructions to discover the printing device comprise instructions to:
discover capabilities of the discovered printing device, including a page description language (PDL) utilized, by the discovered printing device.

3. The storage medium of claim 1, wherein the discovered printing device is accessible to the client computing device via a direct wired or wireless connection, or is accessible to the client computing device via a computer network and is not directly accessible by the remote platform server.

4. The storage medium of claim 1, wherein the discovered printing device has no print queue installed at the client computing device and has no print queue installed at the remote platform server.

5. The storage medium of claim 1, wherein:
the instructions to discover comprise instructions to:
in response to the command, perform a broadcast discovery process to discover a plurality of printing devices and their respective capabilities, each accessible by the client computing device and not installed on the client computing device for printing; and
provide, via the remote platform access protocol, identification of each of the discovered printing devices and their capabilities to the remote platform server.

6. The storage medium of claim 1, wherein:
the instructions to discover comprise instructions to determine address information for the discovered printing device; and
the instructions to provide the print-ready print data comprise instructions to provide the print-ready print data to the discovered printing device using the determined address information.

7. The storage medium of claim 1, wherein:
the instructions to discover comprise instructions to perform a directed discovery process to discover at least one specified printing device;
at least some of the instructions of the storage medium comprise instructions of a plugin to the remote platform access client; and
communications between remote platform server and the instructions of the plugin are provided via a virtual channel of the remote platform protocol.

8. A system of a remote platform server comprising:
a receive engine to receive, from a dynamic print driver of the remote platform server, a request to perform discovery of printing devices;
a discovery engine to provide, via a remote platform protocol, a command to a remote platform access client of a client computing device to perform local discovery for at least one printing device, in response to the request;
an acquisition engine to acquire, from the remote platform access client, identification of a printing device discovered by the remote platform access client in response to the command and not installed on the client computing device for printing, and identification of a page description language (PDL) utilized by the identified printing device;
a data engine to acquire, from the dynamic print driver, print data in print-ready format of the identified PDL for the discovered printing device; and
a provide engine to provide the print data in the print-ready format to the discovered printing device via the remote platform access client without any rendering at the client computing device and bypassing the print system of the client computing device.

9. The system of claim 8, further comprising:
an identification engine to provide, to the dynamic print driver, the identification of the discovered printing device and the identification of the PDL,
wherein the print data is provided from the remote platform server to the remote platform access client via a virtual channel of the remote platform protocol.

10. The system of claim 8, wherein no print queue exists for the discovered printing device at either the remote platform server or the client computing device, and the print data is provided to the discovered printing device without installing any print queue for the discovered printing device at either the remote platform server or the client computing device.

11. The system of claim 8, wherein:
the acquisition engine is to acquire, from the remote platform access client, identification of a plurality of printing devices each discovered by the remote platform access client and not installed on the client computing device for printing, and identification of their respective PDLs.

12. The system of claim 11, further comprising:
the dynamic print driver, including:
a request engine to acquire, from an application executing on a remote platform implemented by the remote platform server, a request to print content; and
a device engine to acquire the identification of the discovered printing devices and their PDLs;
a selection engine to acquire selection of one of the discovered printing devices; and
a render engine to render the print content to generate the print data in the print-ready format of the identified PDL for the selected printing device; and
wherein the provide engine is to provide the print data in the print-ready format to the selected printing device via the remote platform access client.

13. A method comprising:
acquiring, with a remote platform access client of a client computing device, a command to perform local discovery for at least one printing device, from a remote platform server via a remote platform protocol;
in response to the command, discovering, with the remote platform access client, a locally accessible printing device and a page description language (PDL) utilized by the discovered printing device, the discovered printing device having no print queue installed on either of the client computing device or the remote platform server;
providing identification of the discovered printing device and the PDL to the remote platform server from the remote platform access client via the remote platform protocol;
acquiring, with the remote platform access client from the remote platform server via the remote platform protocol, a print instruction indicating the discovered printing device and print data in print-ready format of the discovered PDL for the indicated printing device; and
in response to the print instruction, providing the print-ready print data from the remote platform access client to the discovered printing device indicated in the print instruction without any rendering at the client computing device and bypassing the print system of the client computing device.

14. The method of claim 13 wherein no print driver for the discovered printing device is installed at the client computing device.

15. The method of claim 13, wherein:
the discovering comprises:
discovering, with the remote platform access client, a plurality of locally accessible printing devices and respective PDLs utilized by the discovered printing devices, the discovered printing devices each having no print queue installed on either of the client computing device or the remote platform server; and
storing in memory of the client computing device, for each discovered printing device, address information useable to access the printing device; and
the providing comprises providing the print ready print data to the discovered printing device indicated in the print instruction using the stored address information.
